(19) United States
(12) Patent Application Publication
(10) Pub. No.: US 2013/0152556 A1
(43) Pub. Date: Jun. 20, 2013

(54) FLUID INJECTOR HAVING HEATER

(71) Applicants: Glenn B. Cox, Peoria, IL (US); Sridhar Thangaswamy, Peoria, IL (US)

(72) Inventors: Glenn B. Cox, Peoria, IL (US); Sridhar Thangaswamy, Peoria, IL (US)

(73) Assignee: CATERPILLAR INC., Peoria, IL (US)

(21) Appl. No.: 13/328,448

(22) Filed: Dec. 16, 2011

(51) Int. Cl. F01N 3/18; B05B 1/24

(52) U.S. Cl. 60/295; 239/135

(57) ABSTRACT

A fluid injector unit for use in an exhaust treatment system includes; a fluid injector having a fluid receiving end and a fluid injecting end, a heater disposed about the fluid injecting end of the fluid injector, an electrical contact member electrically connected to the heater, and a thermal ground disposed about a distal end of the electrical contact member from the heater.

### TECHNICAL FIELD

The present disclosure is directed to a fluid injector and, more particularly, to a fluid injector having a heater.

### BACKGROUND

Engines, including diesel engines, gasoline engines, gaseous fuel powered engines, and other engines known in the art exhaust a complex mixture of emissions. These emissions include particulate matter commonly referred to as soot or particulate matter. Exhaust emission standards and regulations have become more stringent and the amount of particulate matter emitted from an engine is regulated depending on the type of engine, size of engine, and/or class of engine.

One method implemented by engine manufacturers to comply with the regulation of particulate matter exhausted to the environment has been to remove the particulate matter from the exhaust flow of an engine with a device called a particulate trap or diesel particulate filter (DPF). A particulate trap is a filter designed to trap particulate matter and typically consists of a wire mesh or ceramic honeycomb medium. However, the use of the particulate trap for extended periods of time may cause the particulate matter to build up in the medium, thereby reducing the functionality of the filter and subsequent engine performance.

There is a plurality of methods for removing particulate matter from the medium. In one method, the collected particulate matter may be removed from the filter through a process called regeneration. To initiate regeneration of the filter, the temperature of the particulate matter trapped within the filter is elevated to a combustion threshold of the particulate matter, i.e., a temperature at which the particulate matter is combusted. One way to elevate the temperature of the particulate matter is to inject a catalyst such as diesel fuel into the exhaust flow of the engine and ignite the injected fuel. Alternatively, the catalyst may be injected into the exhaust stream to be deposited on the particulate matter on the medium, at which point an exothermic reaction may take place on the medium itself.

After the regeneration event, the supply of fuel is shut off. However, some fuel may remain within the fuel injector or the fuel lines that direct fuel to the injector. This remaining fuel, when subjected to the harsh conditions of the exhaust stream may coke or be partially burned, leaving behind a solid residue that can restrict or even block the fuel injector. In addition, it may be possible for particulate matter from the exhaust flow to enter and block the injector. For this reason, it may be beneficial to periodically purge the injector of fuel and/or any built up residue or particulate matter between regeneration events.

One method of purging a fuel injector is described in U.S. Pat. No. 4,987,738 (the '738 patent) issued to Lopez-Crevillen et al. on Jan. 29, 1991. Specifically, the '738 patent discloses a particulate filter having a burner used to combust trapped particulates. The burner includes a fuel injector nozzle for injecting fuel into the burner during regeneration. As illustrated in FIG. 1 of the '738 patent, a fuel pump supplies fuel to the injector nozzle via a passageway axially aligned with a bore of the nozzle. In order to maintain efficient and reliable operation of the burner, a supply of purge air is directed through the axially aligned passageway to the fuel injector nozzle following a regeneration event to purge the nozzle of fuel. Purge air continues to flow through the injector nozzle until a subsequent regeneration event.

Although the burner of the '738 patent may benefit somewhat from the purging process described above, the gain may be expensive. In particular, the additional passageways required to support the air purging may increase machining cost, component cost, and assembly time. And, the continuous flow of purge air may be expensive to maintain and increase the risk of debris fouling the fluid injector nozzle.

The fluid injector of the present disclosure solves one or more of the problems set forth above.

### SUMMARY

A fluid injector unit for use in an exhaust treatment system includes; a fluid injector having a fluid receiving end and a fluid injecting end, a heater disposed about the fluid injecting end of the fluid injector, an electrical contact member electrically connected to the heater, and a thermal ground disposed about a distal end of the electrical contact member from the heater.

Other features and aspects of this disclosure will be apparent from the following description and the accompanying drawings.

### BRIEF DESCRIPTION OF THE DRAWINGS

FIG. 1 is a schematic and diagrammatic illustration of an exemplary disclosed power unit;

FIG. 2 is an exploded view of an exemplary disclosed exhaust treatment device for use with the power unit of FIG. 1;

FIG. 3 is a cross-sectional illustration of the exhaust treatment device of FIG. 2;

FIG. 4 is a cross-sectional illustration of a fluid injector and heater for use with the exhaust treatment device of FIGS. 2 and 3;

### DETAILED DESCRIPTION

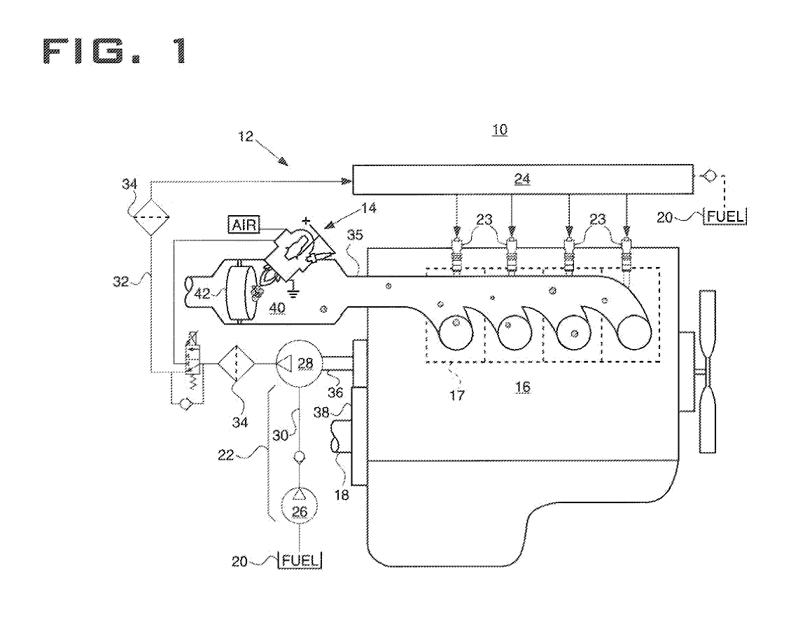

FIG. 1 illustrates a power unit 10 having a fuel system 12 and an auxiliary regeneration system 14. For the purposes of this disclosure, power unit 10 is depicted and described as a four-stroke diesel engine. One skilled in the art will recognize, however, that power unit 10 may be any other type of internal combustion engine such as, for example, a gasoline or a gaseous fuel-powered engine. Power unit 10 may include an engine block 16 that at least partially defines a plurality of combustion chambers 17. In the illustrated embodiment, power unit 10 includes four combustion chambers 17. However, it is contemplated that power unit 10 may include a greater or lesser number of combustion chambers 17 and that combustion chambers 17 may be disposed in an “in-line” configuration, a “V” configuration, a rotary configuration, or any other suitable configuration.

As also shown in FIG. 1, power unit 10 may include a crankshaft 18 that is rotatably disposed within engine block 16. A connecting rod (not shown) may connect at least one of a plurality of pistons (not shown) to crankshaft 18 so that a sliding motion of each piston within the respective combustion chamber 17 results in a rotation of crankshaft 18. Similarly, a rotation of crankshaft 18 may result in a sliding motion of the pistons.

Fuel system 12 may include components that cooperate to deliver injections of pressurized fuel into each of combustion chambers 17. Specifically, fuel system 12 may be a common rail system and include a tank 20 configured to hold a supply of fuel, and a fuel pumping arrangement 22 configured to pressurize the fuel and direct the pressurized fuel to a plurality of fuel injectors 23 by way of a common rail 24.

Fuel pumping arrangement 22 may include one or more pumping devices that function to increase the pressure of the fuel and direct one or more pressurized streams of fuel to common rail 24. In one example, fuel pumping arrangement 22 includes a low pressure source 26 and a high pressure source 28 disposed in series and fluidly connected by way of a fuel line 30. Low pressure source 26 may embody a transfer pump that provides low pressure feed to high pressure source 28. High pressure source 28 may receive the low pressure feed and increase the pressure of the fuel to as much as 300 MPa in some cases. High pressure source 28 may be connected to common rail 24 by way of a fuel line 32. One or more filtering elements 34, such as a primary filter and a secondary filter, may be disposed in fluid communication with fuel line 32 in series relation to remove debris and/or water from the fuel pressurized by fuel pumping arrangement 22.

In one embodiment, one or both of low and high pressure sources 26, 28 may be operatively connected to power unit 10 and driven by crankshaft 18. Low and/or high pressure sources 26, 28 may be connected with crankshaft 18 in any manner readily apparent to one skilled in the art where a rotation of crankshaft 18 will result in a corresponding driving rotation of a pump shaft. For example, a pump driveshaft 36 of high pressure source 28 is shown in FIG. 1 as being connected to crankshaft 18 through a gear train 38. It is contemplated, however, that one or both of low and high pressure sources 26, 28 may alternatively be driven electrically, hydraulically, pneumatically, or in any other appropriate manner. It is further contemplated that fuel system 12 may alternatively embody another type of fuel system such as, for example, a mechanical unit fuel injector system or a hydraulic unit fuel injector system where the pressure of the injected fuel is generated or enhanced within individual injectors without the use of the high pressure source 28 or the common rail 24.

Auxiliary regeneration system 14 may be associated with an exhaust treatment device 40. In particular, exhaust from power unit 10 may be communicated via exhaust passageway 35 to an end portion of exhaust passageway 35 (not shown), where the exhaust may be released into the atmosphere. Prior to reaching the end portion of exhaust passageway 35, the exhaust may pass through exhaust treatment device 40. In exhaust treatment device 40, exhaust constituents, such as particulate matter, gaseous oxides of nitrogen (NOx), unburnt hydrocarbons (HC), and other constituents, may be removed from the exhaust flow or otherwise converted to innocuous gases. In one example, exhaust treatment device 40 may include a wire mesh or ceramic honeycomb filtration medium 42 situated to remove particulate matter from the exhaust flow. Over time, the particulate matter may build up in filtration medium 42 and, if left unchecked, the particulate matter buildup could be significant enough to restrict or even block the flow of exhaust through exhaust treatment device 40, allowing backpressure within power unit 10 to increase. An increase in the backpressure of power unit 10 could reduce the power unit's ability to draw in fresh air, resulting in decreased performance, increased exhaust temperatures, and increased fuel consumption.

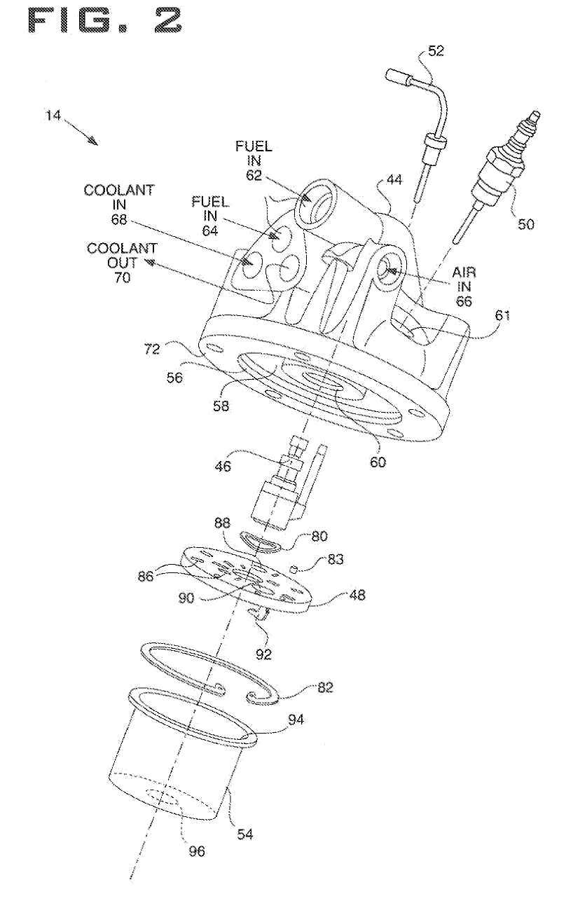

As illustrated in FIG. 2, auxiliary regeneration system 14 may include components that cooperate to periodically reduce the buildup of particulate matter within exhaust treatment device 40. These components may include, among other things, a housing 44, an injector unit 46, a mixing plate 48, a spark plug 50, a thermocouple 52, and a combustion canister 54. It is contemplated that auxiliary regeneration system 14 may include additional or different components, such as, for example, one or more pilot injectors, additional main injectors, a controller, a pressure sensor, a flow sensor, a flow blocking device, and other components known in the art. In addition, it is contemplated that auxiliary regeneration system 14 may omit one or more components listed above. It is further contemplated that instead of, or in addition to, filtration medium 42 (see FIG. 1), exhaust treatment device 40 may include a Selective Catalytic Reduction (SCR) device and an associated injector (not shown) similar to injector unit 46 for introducing a reductant such as, for example, urea into the exhaust flow upstream of the SCR device.

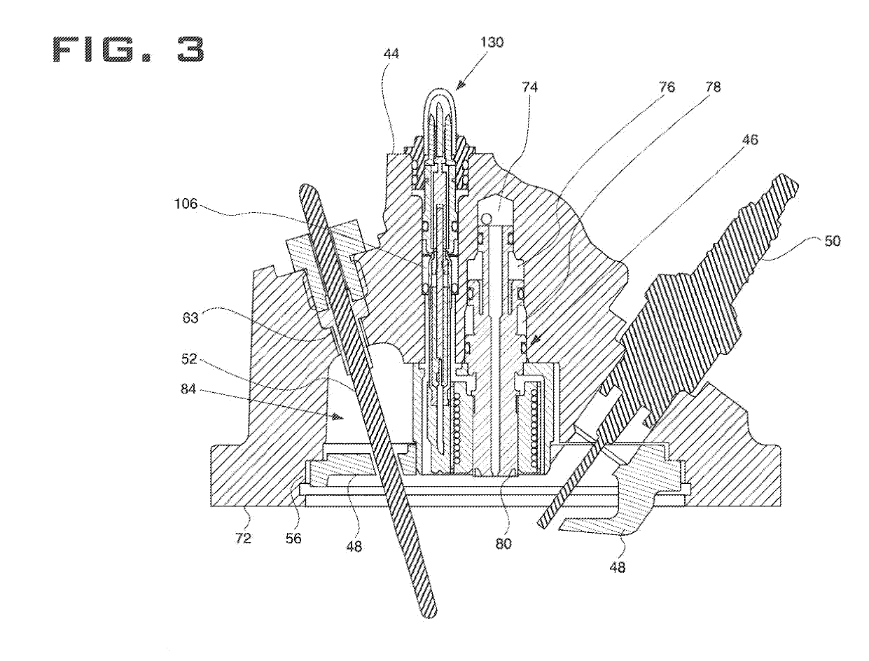

Housing 44 may receive and fluidly interconnect injector unit 46, mixing plate 48, spark plug 50, and thermocouple 52. In particular, housing 44 may have a central stepped bore 56, an annular recessed opening 58, a centrally located bore 60, a first radially offset bore 61, and a second radially offset bore 63 (illustrated in FIG. 3). Housing 44 may also include a pilot fuel passage 62, a main fuel passage 64, an air supply passage 66, and inlet and outlet cooling passages 68 and 70, respectively. One or more check valves (not shown) may be situated in any one or all of these passages, if desired, to ensure unidirectional flow of the respective fluids within the passages and/or to reduce or minimize the volumes thereof that could require periodic re-supplying or purging.

Centrally located bore 60 may receive injector unit 46 through an inner surface 72 (referring to the surface of housing 44 illustrated in FIG. 2 as being open to combustion canister 54). Centrally located bore 60, together with injector unit 46 may form a pilot fuel chamber 74 (referring to FIG. 3), a main fuel chamber 76, and a coolant chamber 78 within the steps of centrally located bore 60. Pilot fuel chamber 74 may be fluidly communicated with pilot fuel passage 62, while main fuel chamber 76 may be fluidly communicated with main fuel passage 64. Coolant chamber 78 may be fluidly communicated with both the inlet and outlet cooling passages 68, 70. Mixing plate 48 may retain injector unit 46 within centrally located bore 60 by way of a retaining ring 80 or threaded fastener (not shown). Alternative embodiments may include additional elements, or omit listed elements as appropriate.

Central stepped bore 56 may receive mixing plate 48 also through inner surface 72. Mixing plate 48 may be press-fit completely within central stepped bore 56 and/or held in place with a snap ring 82. Mixing plate 48 may be centrally aligned with injector unit 46 and housing 44, and angularly oriented with respect to housing 44 by way of one or more dowel pins 83.

First radially offset bore 61 may receive spark plug 50 through an external surface of housing 44. In particular, spark plug 50 may include external threads that engage internal threads of first radially offset bore 61. First radially offset bore 61 may be in communication with air supply passage 66, if desired, such that carbon and other contaminates may be periodically purged from first radially offset bore 61 and, thereby, prevented from building on spark plug 50 and causing unintentional arcing thereof.

The second radially offset bore 63 may receive thermocouple 52 through the external surface of housing 44. Similar to spark plug 50, thermocouple 52 may also have external threads that engage internal threads of the second radially located bore. Although no passages are illustrated as communicating fluids with thermocouple 52, it is contemplated that purge fluid such as air from air supply passage 66 may alternatively, or additionally, be directed to the second radially offset bore 63 to reduce or minimize the buildup of contaminates therein, if desired.

Injector unit 46 may be disposed within housing 44 and operable to inject one or more amounts of pressurized fuel (e.g., such as through pilot, main, and/or post injections) into combustion canister 54 at predetermined timings, fuel pressures, and fuel flow rates. The timing of fuel injection into combustion canister 54 may be synchronized with sensory input received from thermocouple 52, one or more pressure sensors (not shown), a timer (not shown), a radio frequency sensor (not shown) or any other similar sensory devices such that the injections of fuel substantially correspond with a buildup of particulate matter within filtration medium 42 (referring to FIG. 1). For example, fuel may be injected as the temperature of the exhaust flowing through exhaust treatment device 40 exceeds a predetermined value. Alternatively or additionally, fuel may be injected as a pressure of the exhaust flowing through exhaust treatment device 40 exceeds a predetermined pressure level or a pressure drop across filtration medium 42 exceeds a predetermined differential value. It is contemplated that fuel may also be injected on a set periodic basis, in addition to or regardless of pressure and temperature conditions, if desired.

Mixing plate 48 (e.g., a swirl plate), together with annular recessed opening 58 of housing 44, may form an air distribution passage 84 (referring to FIG. 3), which may be supplied with compressed air via air supply passage 66. Mixing plate 48 may include a plurality of annularly disposed air vents 86 fluidly communicating air distribution passage 84 with combustion canister 54. Air vents 86 may mix air with injections of fuel inside combustion canister 54 to improve combustion therein. It is contemplated that air vents 86 may additionally or alternatively direct pressurized air to the outer periphery of combustion canister 54 for cooling and/or insulating purposes, if desired. Alternative embodiments include configurations wherein the mixing plate 48 has different shapes or is omitted altogether.

Mixing plate 48 may include openings to accommodate thermocouple 52 and spark plug 50. Specifically, thermocouple 52 may extend into combustion canister 54 via a first through hole 88 in mixing plate 48, while spark plug 50 may extend into combustion canister 54 via a second through hole 90. A grounded electrode 92 may extend from mixing plate 48 proximal second through hole 90 to interact with spark plug 50.

Spark plug 50 may facilitate ignition of fuel sprayed from injector unit 46 into combustion canister 54. Specifically, during a regeneration event or when a catalyst within exhaust treatment device 40 requires an elevated temperature, the temperature of the exhaust exiting power unit 10 may be too low to cause auto-ignition of the fuel sprayed from injector unit 46. To initiate combustion of the fuel and, subsequently, the trapped particulate matter, a small quantity (i.e., a pilot shot) of fuel from injector unit 46 may be sprayed or otherwise injected toward spark plug 50 to create a locally fuel rich atmosphere readily ignitable by spark plug 50. A spark developed between an electrode of spark plug 50 and grounded electrode 92 of mixing plate 48 may ignite the fuel in the locally fuel rich atmosphere creating a flame, which may be jetted or otherwise advanced toward the trapped particulate matter. The flame jet propagating from injector unit 46 may raise the temperature within exhaust treatment device 40 to a level that readily supports efficient ignition of a larger quantity (i.e., a main shot) of fuel from injector unit 46. As the main injection of fuel ignites, the temperature within exhaust treatment device 40 may continue to rise to a level that causes combustion of the particulate matter trapped within filtration medium 42 and/or to a level that supports efficient operation of a catalyst.

Thermocouple 52 may confirm successful ignition of the fuel/air mixture within combustion canister 54 and help to control an injection quantity of fuel based on an achieved temperature. A thermocouple generally includes two dissimilar metals, often embodied in slender members such as wires or rods. The two metals of the thermocouple may be joined at a measuring end of the thermocouple (usually the terminal end) via a soldered junction. When the temperature at the measuring end of the thermocouple changes relative to the temperature at a reference end (i.e., non-measuring end), a measurable voltage may be generated. The value of the measured voltage may be used to determine a temperature at the measuring end of the thermocouple. Thermocouple 52 may extend through mixing plate 48 into combustion canister 54 for indicating the temperature therein. When a temperature measured within combustion canister 54 exceeds a predetermined value, it can be concluded that ignition of the air-fuel mixture has been achieved. Similarly, when the temperature measured within combustion canister 54 drops below the predetermined value, it can be concluded that the flame jet has been extinguished. It is contemplated that the injections of fuel into combustion canister 54, the flow rate or pressure of air directed into combustion canister 54, a temperature of injector unit 46, and/or other temperature dependent operations may be varied in response to the value of the current generated by thermocouple 52. While a thermocouple 52 has been described, alternative embodiments may include different temperature sensor mechanisms as appropriate.

Combustion canister 54 (referring to FIG. 2) may embody a tubular member configured to axially direct an ignited fuel/air mixture (i.e., the flame jet) from auxiliary regeneration system 14 into the exhaust flow of exhaust treatment device 40. In particular, combustion canister 54 may include a central opening 94 that fluidly communicates fuel from injector unit 46 and air from air distribution passage 84 with the exhaust (i.e., central opening 94 may fluidly communicate with or be coextensive with exhaust passageway 35). Combustion canister 54 may employ a flame stabilizing plate 96 at one end of central opening 94 to provide a restriction that reduces or minimizes pulsations within exhaust treatment device 40. That is, the inner diameter of flame stabilizing plate 96 may be less than the inner diameter of central opening 94. Combustion canister 54 may be generally straight and have a predetermined length set during manufacture according to a desired flame introduction location (the distance that a flame resulting from the ignition of the fuel/air mixture extends from combustion canister 54 into the exhaust flow). In one example, this desired introduction location may be about 12 inches from flame stabilizing plate 96 of combustion canister 54.

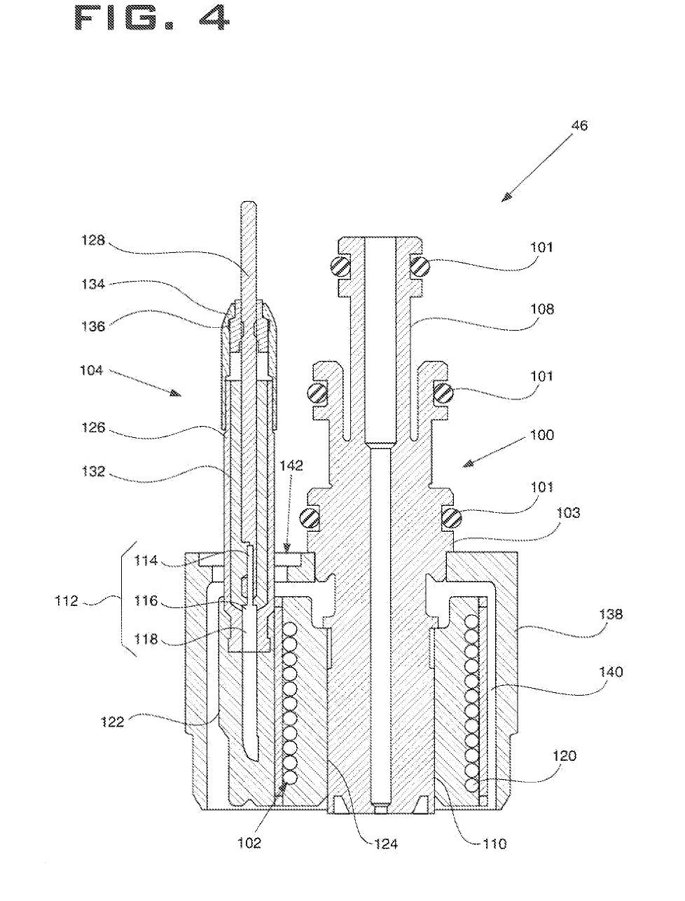

As illustrated in FIGS. 3 and 4, injector unit 46 may be an assembly of multiple components that interact to ensure continued injections of fuel into combustion canister 54 (referring to FIG. 2), even under harsh operating conditions. Specifically, injector unit 46 may include a fluid injector 100 that injects the fuel into the exhaust stream, a heater 102 disposed about the fluid injector 100 and an electrical contact member 104 electrically connected to the heater 102. The injector unit 46 may also include a thermal ground 106 disposed about a distal end of the electrical contact member 104 relative to the heater 102 as will be discussed in more detail below. The various components of the injector unit 46 may be press-fit or otherwise coupled together.

The fluid injector 100 may include a fluid receiving end 108 fluidly coupled to pilot fuel chamber 74 and main fuel chamber 76 and thermally coupled to coolant chamber 78. The fluid injector 100 may also include a fluid injecting end 110 which is surrounded by the heater 102. The fluid injector 100 may have external surfaces of enlarged diameters at opposing ends such that recesses are created therebetween. These recess may at least partially define main fuel chamber 76 and coolant chamber 78 (referring to FIG. 3). That is, coolant from inlet cooling passage 68 may be directly in contact with the external annular surface of the fluid injector 100 at the coolant chamber 78. One or more sealing members 101 may be associated with the enlarged areas of fluid injector 100 to reduce, minimize or prevent fluid leakage and contamination between the fluid injector 100 and housing 44. A flange 103 may help to correctly position the fluid injector 100 within centrally located bore 60.

The heater 102 may include a coaxial wiring 112 including an electrically conductive inner core 114, an electrically insulating sheath 116 surrounding the conductive inner core and a conductive outer sheath 118 surrounding the electrically insulating sheath 116. The coaxial wiring 112 may form at least one heater coil 120 disposed around the fluid injecting end 110 of the fluid injector 100. However, alternative embodiments include alternative wiring configurations, such as an embodiment wherein the heater 102 includes a single layered wiring, e.g., a material with a high electrical resistance connected to ground at one terminal thereof, an embodiment wherein an additional layer of insulation is added to the conductive outer sheath 118, etc.

The coaxial wiring 112 may be press-fit onto a body 122. In order to generate a flow of current through heater 102, housing 44, mixing plate 48, Bellville retaining ring 80, and sleeve 126 may be grounded. With the intention of minimizing the likelihood of short-circuiting between the electrically conductive inner core 114 and housing 44, the electrically conductive inner core 114 may be insulated from housing 44, e.g., via the electrically insulating sheath 116. Coaxial wiring 112 may extend from the at least one heater coil 120 in a vertical direction substantially parallel with an axial direction of the fluid injector 100 such that the effects of gravity and vibration on the coaxial wiring 112 may be reduced or minimized. It is contemplated that coaxial wiring 112 may, alternatively, extend from the at least one heater coil 120 in a horizontal or other direction, if desired.

Body 122 may embody a generally tubular member fixedly connecting the fluid injecting end 110 of the fluid injector 100 to the heater 102. That is, body 122 may include a central bore 124 that engages the fluid injecting end 110, and an outer annular surface over which heater 102 may be press fit, wire wrapped, brazed, cast, tight clearance fit, or clamped on. Body 122 may also engage the electrical contact member 104. The engagement between body 122, fluid injecting end 110 of the fluid injector 100, and heater 102 may facilitate the conductive transfer of heat from heater 102 to the fluid injecting end 110. In one embodiment, the body 122 may be made of brass or other material with similar characteristics.

The electrical contact member 104 is electrically connected to the coaxial wiring 112 and provides a path for electrical connection between the heater 102 and an external power supply (not shown), such as an alternator or battery of power unit 10. The electrical contact member is generally cylindrical in shape and includes a sleeve 126 coupled to the electrically conductive outer sheath 118 of the coaxial wiring 112, and the body 122. The sleeve 126 partially encloses an electrical contact pin 128 disposed axially therewithin. The electrical contact pin 128 protrudes from the sleeve 126 at a distal end relative to the heater 102 for connection with a female-type receptacle 130 as will be described in more detail below. The electrical contact pin 128 is electrically connected with the electrically conductive inner core 114 of the coaxial wiring 112 forming the heater 102. The electrical contact member 104 also includes a thermally and electrically insulative layer 132 disposed between the sleeve 126 and the electrical contact pin 128. The electrically insulative layer 132 prevents shorting between the electrical contact pin 128 and the housing 44, which is grounded. The sleeve 126 includes a tapered shoulder region which connects with an end cap 134. The end cap 134 may be press-fit, soldered, laser welded, or otherwise assembled with the sleeve 126. Intermediate between the end cap 134 and the electrical contact pin 128 is an elastomeric end seal 136. The elastomeric end seal 136 axially surrounds a portion of the electrical contact pin 128 corresponding to the distal end of the electrical contact member 104. The elastomeric end seal 136 prevents contamination of the electrically insulative layer 132 as will be discussed in more detail below.

A heat shield 138 may substantially enclose heater 102 to reduce or minimize the amount of thermal energy convected and/or radiated to the air within air distribution passage 84 (referring to FIG. 3). That is, heat shield 138 may annularly surround the at least one heater coil 120 and be spaced apart from the at least one heater coil 120 such that an insulative air gap 140 is created with the heat shield 138. An annular portion of heat shield 138 may include a tapered and shouldered through hole 142 that accommodates the connection of the at least one heater coil 120 to the electrical contact pin 128. In one embodiment, the injector unit 46, including fluid injector 100, heater 102 and heat shield 138, may be retained in place by the mixing plate 48.

Pressurized fuel may be directed into and around the fluid receiving end 108 of the fluid injector 100 toward the fluid injecting end 110 for injection, while coolant may be directed around the fluid receiving end 108 to prevent coking of fuel within the fluid injector 100. Between injection events, current may be selectively applied to heater 102 to evaporate and/or burn away any residual fuel or buildup within the fluid injecting end 110 of the fluid injector 100 (i.e., purge a fluid injecting end 110 of injector unit 46). External surfaces of injector unit 46 may also be purged of deposits and fuel, thereby maintaining spray angle and quality. Heat shield 138 may reduce or minimize the amount of heat convected and/or radiated away from heater 102 during the purge process.

Thermal ground 106 is disposed between the end cap 134 and housing 44 when the injector unit 46 is assembled into centrally located bore 60. In one embodiment, the thermal ground 106 may be formed in-place as a thermally conductive polymer adhesive compound. Specifically, the thermal ground 106 may be an adhesive based compound injected in a radial gap between the distal end of the electrical contact member 104 relative to the heater 102 and the housing 44. However, alternative embodiments include configurations wherein the thermal ground 106 may be formed via various mechanisms. In one embodiment, the thermal ground 106 may be a room-temperature cured adhesive based compound, although alternative embodiments of the thermal ground 106 may be a heat cured adhesive compound, an ultra-violet (UV) light cured adhesive compound, or adhesive compounds cured in various other ways. In one embodiment, the thermal ground 106 is disposed in contact with the housing 44 and only the end cap 134 of the electrical contact member. In such an embodiment, the elastomeric end seal 136 may be exposed to contact a portion of the female-type receptacle 130 in order to form a fluid-tight seal. In the illustrated embodiment, the thermal ground 106 is disposed in contact with an O-ring seal 144 that prevents fluids, contaminants and/or contaminative fluids from traveling axially along the centrally located bore 60 and also contains the thermal ground 106 axial retention during its curing process. The thermal ground 106 helps to extend the life of the elastomeric end seal 136 and the O-ring seal 144 as will be discussed in more detail below.

### INDUSTRIAL APPLICABILITY

The fluid injector of the present disclosure may be applicable to a variety of exhaust treatment devices including, for example, particulate traps requiring periodic regeneration, catalytic converters requiring a predetermined temperature for optimal operation, SCR devices requiring the injection of ammonia or another catalyst, and other similar devices known in the art. In fact, the disclosed injector may be implemented into any engine system that benefits from clog-free injector operation. The operation of power unit 10 will now be explained.

Referring to FIG. 1, air and fuel may be drawn into combustion chambers 17 of power unit 10 for subsequent combustion. Specifically, fuel from fuel system 12 may be injected into combustion chambers 17 of power unit 10, mixed with the air therein, and combusted to produce a mechanical work output and an exhaust flow of hot gases. The exhaust flow may contain a complex mixture of exhaust products composed of gaseous and solid material, which can include particulate matter. As this particulate containing exhaust flow is directed from combustion chambers 17 through exhaust treatment device 40, particulate matter may be strained from the exhaust flow by filtration medium 42. Over time, the particulate matter may build up in filtration medium 42 and, if left unchecked, the buildup could be significant enough to restrict, or even block the flow of exhaust through exhaust treatment device 40. As indicated above, the restriction of exhaust flow from power unit 10 may increase the backpressure of power unit 10 and reduce the unit's ability to draw in fresh air, resulting in decreased performance of power unit 10, increased exhaust temperatures, and poor fuel consumption.

To prevent the undesired buildup of particulate matter within exhaust treatment device 40, filtration medium 42 may be regenerated. Regeneration may be periodic or based on a triggering condition, such as, for example, an elapsed time of engine operation, a pressure differential measured across filtration medium 42, a temperature of the exhaust flowing from power unit 10, a radio frequency measurement of particulate matter density, or any other condition known in the art.

To initiate regeneration, injector unit 46 may be caused to selectively pass fuel into exhaust treatment device 40 at a desired rate (i.e., an injection event). As a pilot injection of fuel from injector unit 46 sprays into combustion canister 54, a spark from spark plug 50 may ignite the fuel. As a main injection of fuel from injector unit 46 is passed into exhaust treatment device 40, the burning pilot flow of fuel may ignite the main flow of fuel. The ignited main flow of fuel may then raise the temperature of the particulate matter trapped within filtration medium 42 to the combustion level of the entrapped particulate matter, burning away the particulate matter and, thereby, regenerating filtration medium 42.

Between regeneration events (the regeneration events including injection events), injector unit 46 may be selectively purged of fuel and any accumulated buildup (i.e., heat to evaporate or burn away fuel and/or accumulated buildup) to ensure proper operation thereof. The purge process may begin when a purge trigger is received or recognized by a controller. Purging may be triggered in a number of different ways. For example, purging may be triggered when a time elapsed since a previous purge event has exceeded a threshold time period. In some situations, this threshold time period may be in the range of 20-60 hours and, more specifically, about 25 hours. In another example, purging may be triggered after the successful completion of each regeneration event described above. In yet another example, purging may be triggered when a regeneration event has failed (i.e., when ignition of the injected fuel can not be confirmed, when a temperature of the particulate matter has failed to reach its combustion threshold temperature, and/or when too many losses of combustion during a regeneration event have occurred). It is contemplated that other purge triggers may also or alternatively be employed, if desired.

The next step after initiating the desired purge process may include determining what triggered the desired purge process. As described above, purge processes may be triggered in a number of different ways. If the trigger is the successful completion of a regeneration event, the desired purge process may include only the warming of injector unit 46 to evaporate any fuel remaining within the fluid injecting end 110 of the fluid injector 100. If warming is desired, the appropriate waveform may be communicated to the heater 102 via the electrical contact member 104 such that the temperature of heater 102 reaches about 300° C. and is maintained for about 10-15 minutes.

However, if the trigger is an amount of time elapsed since a previous purge event or an abnormal pressure decay rate of fuel within injector unit 46, a purge event requiring a higher temperature and/or heating duration may be desired. At this level of purging, the waveform directed to heater 102 may result in temperatures up to about 475° C. being maintained for a duration of about one hour.

If the trigger is a failed regeneration event, it may be concluded that injector unit 46 may be at least partially clogged (i.e., failed injection event). In order to unclog injector unit 46, the temperature and duration of heater 102 may be increased even further. At this level of purging, the waveform directed to heater 102 may result in temperatures that exceed 475° C. for more than one hour. It is contemplated that, after a failed regeneration event, purging in an attempt to unclog injector unit 46 may be limited to a predetermined number of events. That is, if, for example, a regeneration event fails after just completing a high temperature and/or long duration purge, other precautionary measures may be taken such as warning an operator of power unit 10, shutting down power unit 10, and other such measures, if desired.

An electrical short in the electrical contact member 104 may result in an inability of the injector unit 46 to function as desired. The injector unit 46 functions in an environment with large temporal and spatial fluctuations in temperature. Specifically, temperatures near the at least one heater coil 120 may reach 200° C. to 250° C. This thermal energy may be conducted by the at least one heater coil 120 along the electrically conductive inner core 114 to the electrical contact pin 128, thereby raising temperatures of adjacent components, such as the elastomeric end seal 136 and the o-ring seal 144. As temperatures and the number of heating cycles increase, the overall life-time of the elastomeric end seal 136 and the o-ring seal 144 may be reduced. Thus, the form-in-place thermal ground 106 may extend the overall life-time of the elastomeric end seal 136 and the o-ring seal 144 by reducing the maximum temperature and amplitude of cyclical temperature changes experienced by the elastomeric end seal 136 and the o-ring seal 144.

If either the elastomeric end seal 136 or the o-ring seal 144 are compromised, the electrically insulative layer 132 may be exposed to hydrocarbons. Such exposure may ultimately lead to a short across the electrically insulative layer 132 as carbon builds within the sleeve 126 and forms a conduction path for the electrical contact pin 128 to ground. This conduction path could render the injector unit 46 inoperative. This disclosure provides a means for extending the life of the elastomeric end seal 136 and the o-ring seal 144 by regulating a maximum temperature of, and controlling the amplitude of temperature swings of, the elastomeric end seal 136 and the o-ring seal 144.

The thermal ground 106 provides a path for conduction of thermal energy away from the electrical contact member 104 and into the relatively cooler housing 44. That is, the thermal ground 106 allows the housing 44 to function as a heat sink for the electrical contact member 104. In some instances, the housing 44 at the location of the thermal ground 106 may be 145-155° C. while the heater 102 is 200-250° C. The housing 44 may be cooler at this location for several reasons. First, the housing 44 extends away from the exhaust passageway 35 and into relatively cooler ambient air. Second, the housing 44 may be cooled by fuel and coolant flowing through the main fuel chamber 76 and the coolant chamber 78 immediately adjacent to the electrical contact member 104. In one embodiment, at least a portion of the housing in contact with the thermal ground is cooled by fluid flow through at least one of the main fuel chamber 76 and the coolant chamber 78.

In the embodiment wherein the thermal ground 106 is formed-in-place, e.g., by curing a liquid thermally conductive polymer adhesive compound the thermal ground 106 provides a relatively large surface area contact between the end cap 134 and the housing 44. That is, the thermal ground 106 may fill all voids between the two components, thus increasing the total surface area for thermal energy transfer. In addition, in such an embodiment, the thermal ground 106 may act as an additional barrier to contaminant entry into the electrical contact member 104. The thermal ground 106 may be coupled to the o-ring seal 144 in such an embodiment due to the nature of the form-in-place deposition process. In addition, the thermal ground 106 may be coupled to the o-ring seal 144 because the housing 44 and the electrical contact member 104 may be non-coaxial.

The disclosed injector configuration may help to ensure continued and successful regeneration events by removing residual fuel and buildup therefrom in an efficient manner with reliable seal performance. Specifically, by heating a nozzle portion of the injector (i.e., that portion of injector unit 46 spraying fuel into combustion canister 54), both residual liquids and solid buildup therein may be efficiently burned away. By removing both the liquids and the solids, the successful operation of the disclosed injector may be prolonged, as compared to a purge system that only removes a bulk of the liquids. In addition, the thermal conduction away from the seals protecting the electrical connection components from contamination will increase the life of the seals.

It will be apparent to those skilled in the art that various modifications and variations can be made to the fluid injector of the present disclosure without departing from the scope of the disclosure. Other embodiments will be apparent to those skilled in the art from consideration of the specification and practice of the injector disclosed herein. For example, although the disclosed injector is illustrated as drawing pressurized fuel from a fuel system, the disclosed injector may alternatively draw pressurized fuel from a separate dedicated source, if desired. Further, although general examples have illustrated the disclosed injector as being associated with fuel for particulate regeneration purposes, it is contemplated that injector unit 46 may just as easily be used to inject ammonia, AdBlue, and/or urea within a Selective Catalytic Reduction (SCR) device, if desired. In addition, it is contemplated that the disclosed heater and control system may be combined with an air- or chemical-purging system to more effectively remove liquid fuel and/or residue from the disclosed injector, if desired. It is intended that the specification and examples be considered as exemplary only, with a true scope of the disclosure being indicated by the following claims and their equivalents.

What is claimed is:

1. A fluid injector unit for use in an exhaust treatment system, comprising:
a fluid injector having a fluid receiving end and a fluid injecting end;
a heater disposed about the fluid injecting end of the fluid injector;
an electrical contact member electrically connected to the heater; and
a thermal ground disposed about a distal end of the electrical contact member from the heater.

2. The fluid injector unit of claim 1, wherein the heater includes a coaxial wiring including a conductive inner core, an electrically insulating sheath surrounding the conductive inner core and a conductive outer sheath surrounding the electrically insulating sheath.

3. The fluid injector unit of claim 2, wherein the electrical contact member includes:
a sleeve coupled to the conductive outer sheath of the heater;
an electrical contact pin disposed axially within the sleeve and protruding therefrom, the electrical contact pin being electrically connected to the conductive inner core of the heater;
an insulative layer disposed between the sleeve and the electrical contact pin;
an elastomeric end seal axially surrounding a portion of the electrical contact pin corresponding to the distal end of the electrical contact member; and
an end cap axially surrounding the elastomeric end seal and at least a portion of the sleeve.

4. The fluid injector unit of claim 3, wherein the thermal ground is in contact with only the end cap of the electrical contact member.

5. The fluid injector unit of claim 1, wherein the thermal ground is a thermally conductive polymer adhesive compound.

6. The fluid injector of claim 1, wherein the heater includes at least one heater coil disposed around the fluid injecting end of the fluid injector.

7. The fluid injector unit of claim 6, further comprising a heat shield disposed substantially surrounding the at least one heater coil.

8. The fluid injector unit of claim 7, further comprising an insulative air gap disposed between the at least one heater coil and the heat shield.

9. The fluid injector of claim 7, wherein the fluid injector, the heater, and the heat shield are retained in place by a mixing plate.

10. The fluid injector of claim 1, wherein a fluid received and injected by the fluid injector is diesel fuel.

11. A regeneration system comprising:
a housing; and
a fluid injector unit received within the housing, the fluid injector unit including:
a fluid injector having a fluid receiving end and a fluid injecting end;
a heater disposed about the fluid injecting end of the fluid injector;
an electrical contact member electrically connected to the heater and received within the housing; and
a thermal ground disposed about a distal end of the electrical contact member wherein the thermal ground thermally couples the electrical contact member to the housing.

12. The exhaust aftertreatment auxiliary regeneration system of claim 11, further including a coolant chamber disposed within the housing and axially surrounding at least a portion of the fluid injector.

13. The exhaust aftertreatment auxiliary regeneration system of claim 12, further including a fuel chamber disposed within the housing and axially surrounding at least a portion of the fluid injector.

14. The exhaust aftertreatment auxiliary regeneration system of claim 13, wherein the thermal ground thermally connects the distal end of the electrical contact member with the housing.

15. The exhaust aftertreatment auxiliary regeneration system of claim 14, wherein at least a portion of the housing in contact with the thermal ground is cooled by fluid flow through at least one of the coolant chamber and the fuel chamber.

16. The exhaust aftertreatment auxiliary regeneration system of claim 11, further comprising an O-ring seal coupled to the thermal ground and axially surrounding the distal end of the electrical contact member.

17. The exhaust aftertreatment auxiliary regeneration system of claim 11, further comprising a spark plug disposed in the housing.

18. The exhaust aftertreatment auxiliary regeneration system of claim 11, further comprising a thermocouple disposed in the housing.

19. The exhaust aftertreatment auxiliary regeneration system of claim 11, further comprising a mixing plate connecting the fluid injector unit and the housing.

20. An exhaust treatment system, comprising:
a passageway configured to receive exhaust; and
an auxiliary regeneration system configured to inject fluid into the exhaust within the passageway,
wherein the auxiliary regeneration system includes:
a fluid injector having a fluid receiving end and a fluid injecting end;
a heater disposed about the fluid injecting end of the fluid injector;
an electrical contact member electrically connected to the heater; and
a thermal ground thermally coupling the housing and the electrical contact module, wherein the thermal ground is disposed at an end of the electrical contact module opposite to the heater and the passageway.
